(19) United States
(12) Patent Application Publication
(10) Pub. No.: US 2012/0102094 A1
(43) Pub. Date: Apr. 26, 2012

(54) MULTI-SCREEN SERVICE SYSTEM AND METHOD FOR PROVIDING CONTENT

(75) Inventors: Seung Il PARK, Seoul (KR); Seung Ji Park, Seoul (KR); Byung Zoo Choi, Seoul (KR)

(73) Assignee: Pantech Co., Ltd., Seoul (KR)

(21) Appl. No.: 13/006,793

(22) Filed: Jan. 14, 2011

(30) Foreign Application Priority Data
Oct. 20, 2010 (KR) 10-2010-0102303

(51) Int. Cl. G06F 15/16

(52) U.S. Cl. 709/203

(57) ABSTRACT

Disclosed herein are a multi-screen service system and method for providing a continuous image based on a user environment. It is possible to provide a continuous image to a user by calculating a buffering time, which is estimated in consideration of an image data size and a network environment, and an expected time of arrival, which is estimated in consideration of current position information and an average speed of a user, and making a request for transmitting content to a content providing server if the expected time of arrival is within the buffering time.

### CROSS-REFERENCE TO RELATED APPLICATION

This application claims priority from and the benefit under 35 U.S.C. §119(a) of Korean Patent Application No. 10-2010-0102303, filed on Oct. 20, 2010, the contents of which are herein incorporated by reference for all purposes.

### BACKGROUND

1. Field

This disclosure relates to a multi-screen service system and method for providing continuous content thereon.

2. Discussion of the Background

A multi-screen service refers to a service for connecting an Internet Protocol television (IPTV), a personal computer (PC) and/or a mobile telephone through a network, for example, the Internet, and enabling users to use content in different locations on different apparatuses so as to provide a continuous service even if a place or apparatus is changed.

In order to provide a service across different apparatuses, if a content reproduction time of a first terminal (for example, a mobile terminal), which receives content from a content providing server and reproduces the content, has elapsed, a request for transmitting the content to a second terminal is made to the content providing server. Then, the content providing server begins to transmit the same content to the second terminal in response to the request for transmitting the content.

Alternatively, if a first terminal which receives content from a content providing server and reproduces the content approaches a second terminal (for example, an IPTV) to within a predetermined distance, the first terminal makes a request for transmitting the content to the second terminal to the content providing server, and the content providing server begins to transmit the same content to the second terminal in response to the request for transmitting the content.

However, in the case where the request for transmitting the content is made to the content providing server based on the reproduction time and the distance between the two terminals, a user may arrive early at a destination due to a road condition and, in this case, image data necessary for reproduction may not have been transmitted. Then, the user has to wait until buffering is completed.

Also, the size of image data to be transmitted or a network environment may not be considered. If the network environment is poor and a data transfer rate is very low, image data necessary for reproduction may not have been transmitted even if a user arrives at a destination at an expected time. Then, the user has to wait until buffering is completed.

### SUMMARY

This disclosure is directed to providing a multi-screen service system and method for providing a continuous content between terminals by making a request for transmitting content to a content providing server based on a buffering time which is estimated in consideration of a content or an image data size and a network environment and an expected time of arrival, which is estimated in consideration of current position information and an average speed of a user.

Additional features of the invention will be set forth in the description which follows, and in part will be apparent from the description, or may be learned by practice of the invention.

An exemplary embodiment provides a multi-screen service system, including: a content providing server to receive a request for reproducing an image from a first terminal, to retrieve content to be reproduced by a second terminal from content of the image, to calculate a buffering time of the content based on an image data size and a network transfer rate, to transmit the buffering time and image data to the first terminal, and to transmit the image data of an expected time of arrival to the second terminal in response to a content transmission request of the first terminal; and the first terminal to transmit the request for reproducing the image to the content providing server, to receive the buffering time from the content providing server, to determine the expected time of arrival, and to transmit the request for transmitting the content to the second terminal to the content providing server if the expected time of arrival is within the buffering time.

An exemplary embodiment provides a content providing server including: a terminal information database (DB) to store information about a plurality of terminals available to a multi-screen service; a transmission unit to receive a request for reproducing an image from a first terminal of the plurality of terminals and to transmit a buffering time and image data to the first terminal; a content DB to store content to be provided to the plurality of terminals; a buffering time calculation unit to calculate the buffering time of the content to be transmitted to a second terminal of the plurality of terminals; and a control unit to retrieve content to be reproduced by the second terminal from content of the image based on information about the second terminal in response to the image reproduction request of the first terminal and to transmit information about the retrieved content and a network transfer rate to the buffering time calculation unit.

An exemplary embodiment provides a terminal including: a transmission/reception unit to transmit a request for reproducing an image to a content providing server and to receive image data and a buffering time from the content providing server; an expected time of arrival calculation unit to detect current position information and to calculate an expected time of arrival; and a control unit to transmit a request for transmitting content to a second terminal to the content providing server if the expected time of arrival calculated by the expected time of arrival calculation unit is within the buffering time.

An exemplary embodiment provides a terminal including: a transmission/reception unit to receive image data of an expected time of arrival from a content providing server; a short-range communication unit to receive a time stamp transmitted from a first terminal using a short-range wireless communication method; and an image reproduction unit to retrieve a frame to be reproduced from the image data received from the content providing server using the time stamp and to perform reproduction from the retrieved frame.

An exemplary embodiment provides a multi-screen service method, including: transmitting a request for reproducing an image from a first terminal to a content providing server; at the content providing server, retrieving content to be reproduced by a second terminal from content of the image and transmitting a buffering time of the content calculated in consideration of an image data size and a network transfer rate to the second terminal; at the first terminal, determining an expected time of arrival and transmitting a request for transmitting the content to the second terminal to the content providing server; and at the content providing server, transmitting image data of the expected time of arrival to the second terminal in response to the request for transmitting the content.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram showing the configuration of a multi screen player service system according to an exemplary embodiment.

FIG. 2 is a schematic diagram showing the configuration of a content providing server according to an exemplary embodiment.

FIG. 3 is a schematic diagram showing the configuration of a first terminal according to an exemplary embodiment.

FIG. 4 is a schematic diagram showing the configuration of a second terminal according to an exemplary embodiment.

FIG. 5 is a flowchart illustrating a multi-screen service method according to an exemplary embodiment.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be through, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. As used herein, an image may be a moving image, such as a video, or content, such as information, text, data, audio, a game, a still image, a web browser, a window, and the like shown on a display of a terminal.

In the drawings, like reference numerals denote like elements. The shape, size and regions, and the like, of the drawings may be exaggerated for clarity.

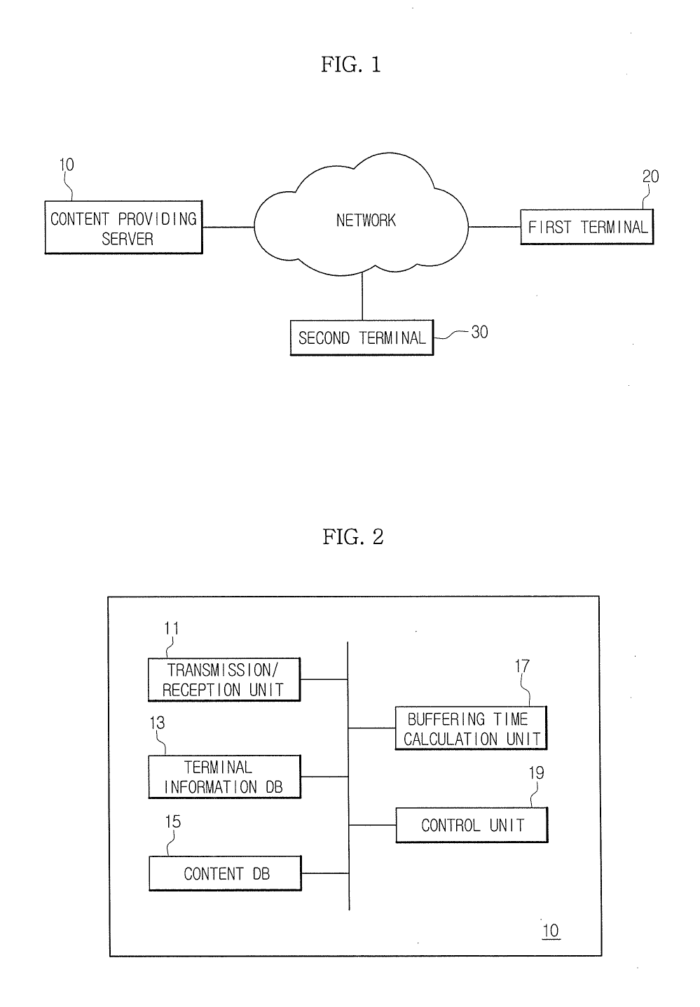

FIG. 1 is a schematic diagram showing the configuration of a multi screen player service system according to an exemplary embodiment. Referring to FIG. 1, if a first terminal 20 makes a request for reproducing an image selected by a terminal user, a content providing server 10 retrieves content to be reproduced by a second terminal 30 from content of the image selected by the terminal user, calculates a buffering time of the content based on an image data size and a current network transfer rate of the retrieved content, and transmits the calculated buffering time and image data to the first terminal 20. Thereafter, if a request for transmitting content to the second terminal 30 is received from the first terminal 20, the content providing server attempts to access the second terminal 30 in response to the request for transmitting the content and transmits image data of a time when the first terminal 20 will arrive at a destination (hereinafter, referred to as an expected time of arrival) to the accessed second terminal 30.

The first terminal 20 makes a request for reproducing the image selected by the terminal user to the content providing server 10 and receives the image data and the buffering time. While the image data received from the content providing server 10 is reproduced and provided to the terminal user, the first terminal detects current position information, calculates the expected time of arrival, determines whether the expected time of arrival is within, or equal to or less than, the buffering time, and makes the request for transmitting the content to the second terminal 30 to the content providing server 10 if the expected time of arrival is within the buffering time. When arriving at the destination, the first terminal retrieves information about the second terminal and transmits a time stamp of a frame which is currently being reproduced to the second terminal 30. The first terminal 20 may periodically detect the current position information but aspects are not limited thereto.

The first terminal 20 may be a mobile terminal and may be implemented as a Global System for Mobile Communications (GSM) phone, a Wideband CDMA (W-CDMA) phone, a CDMA-2000 phone, a Mobile Broadband System (MBS) phone, a smart phone, a personal digital assistant (PDA), a tablet computer, or the like; however, aspects are not limited thereto such that the first terminal 20 may be any device capable of providing information in accordance with this disclosure.

The second terminal 30 establishes a connection with the content providing server 10 in response to a connection request of the content providing server 10 and receives the image data transmitted from the content providing server 10. The second terminal retrieves a frame to be reproduced from the image data received from the content providing server 10 based on the time stamp received from the first terminal 20 which arrives at the destination and recognizes the second terminal 30 using a short-range wireless communication scheme and performs reproduction from the retrieved frame.

The second terminal 30 may be a fixed terminal and may be implemented as a personal computer (PC), a laptop computer, an internet protocol television (IPTV), or the like; however, aspects are not limited thereto such that the second terminal 30 may be any device capable of providing information in accordance with this disclosure.

The first terminal 20 and the second terminal 30 may be wired or wireless terminals used by the same user, and information about the first terminal 20 and the second terminal 30 may be registered in the content providing server 10.

The network depicted in FIG. 1 is a data communication network for data transmission and information exchange between the first terminal 20 and the content providing server 10 and data transmission and information exchange between the second terminal 30 and the content providing server 10, and may be a wired Internet network, a mobile communication network, a combination thereof, or the like. Further, although shown and described as a first terminal 20 and a second terminal 30, aspects of each may be provided in the other and/or may be included in a single terminal.

FIG. 2 is a schematic diagram showing the configuration of a content providing server according to an exemplary embodiment. The content providing server 10 includes a transmission/reception unit 11, a terminal information database (DB) 13, a content DB 15, a buffering time calculation unit 17, and a control unit 19.

The transmission/reception unit 11 receives a request for reproducing an image selected by a terminal user and receives a request for transmitting content to the second terminal 30 from the first terminal 20. Under the control of the control unit 19, a buffering time and image data are transmitted to the first terminal 20.

The terminal information DB 13 stores information (for example, CPU performance of the terminals, resolutions, codec types, and the like) about a plurality of terminals used by the terminal user who subscribes to a multi-screen service.

The content DB 15 stores content to be provided to the terminal user.

A plurality of pieces of content of the same image may be stored in the content DB 15 with different sizes so as to be reproduced by different terminals. That is, for the same image, the size of content to be reproduced by a smart phone may be 300 MB while the size of content to be reproduced by an IPTV may be 2 GB. For example, the smart phone may be capable of a resolution of 720×480, a number of frames per second (fps) of 25, and a supportable codec of DivX resulting in a size of the content of 300 MB. And, the IPTV may be capable of a resolution of 1024×960, a number of frames per second (fps) of 30, and a supportable codec being MP4 resulting in a size of the content of 2 GB. Thus, for the same image, e.g., “Avatar”, the content to be reproduced by a PC, the content to be reproduced by an IPTV, and the content to be reproduced by a smart phone may be stored separately in the content DB 15.

The buffering time calculation unit 17 calculates the buffering time of the content to be transmitted to the second terminal 30, based on information (for example, the total number of frames of a content image, a total data size of the content image, and the like) about the content received from the control unit 19 and a network transfer rate. The buffering time may be calculated using Equation 1.

Buffering time=image data size/network transfer rate Equation 1

In Equation 1, the image data size is equal to [(the number of frames to be transmitted)/(the total number of frames of the retrieved content)]×(the total data size of the retrieved content), and the network transfer rate is the number of packets transmitted per unit time.

Thus, the buffering time calculated by the buffering time calculation unit 17 is influenced by the network transfer rate. That is, the network transfer rate is changed according to types (for example, a 3G network, a wireless Internet network, a wired Internet network, and the like) of the network over which the second terminal 30 receives image data. Even in the same network, network traffic is changed according to time. If the network transfer rate is high, the amount of data to be transmitted within a predetermined time is increased. In contrast, if the network transfer rate is low, the amount of data to be transmitted within the predetermined time is decreased. Thus, the buffering time may be increased or decreased according to the network transfer rate.

If a request for reproducing an image is received in the content providing server 10 from the first terminal 20 through the transmission/reception unit 11, the control unit 19 retrieves information about the second terminal 30, i.e., the second terminal 30 used by the user of the first terminal 20, from the terminal information DB 13, and retrieves content to be retrieved by the second terminal 30 from the content of the image selected by the terminal user based on the information about the second terminal 30. Assuming that the second terminal 30 is an IPTV and that content having a size of 300 MB, which may be reproduced by a smart phone, and content having a size of 1 GB, which may be reproduced by a PC, are stored in the content DB 15 as content associated with the image selected by the terminal user, the control unit 19 selects the content having the size of 1 GB as content which may be reproduced by the IPTV.

The control unit 19 checks the current transfer rate of the network over which the second terminal 30 receives the image data, transmits the information (for example, the total number of frames of the content image, the total data size of the content image, and the like) about the retrieved content and the network transfer rate to the buffering time calculation unit 17, controls the buffering time calculation unit 17 to calculate the buffering time, and transmits the buffering time and the image data to the first terminal 20 through the transmission/reception unit 11 after receiving the buffering time from the buffering time calculation unit 17.

If a request for transmitting the content to the second terminal 30 is received from the first terminal 10 through the transmission/reception unit 11, the control unit 19 attempts to establish a connection with the second terminal 30 through the transmission/reception unit 11 in response to the request for transmitting the content and transmits image data of an expected time of arrival to the second terminal 30 if the connection with the second terminal 30 is completed. The image data of the expected time of arrival may be image data reproduced by the first terminal at the expected time of arrival of the first terminal to a location of the second terminal. When transmitting the image data of the expected time of arrival to the second terminal 30, the control unit 19 may estimate an error which may occur due to variable factors and may transmit redundant image data before and after the image data with respect to the expected time of arrival.

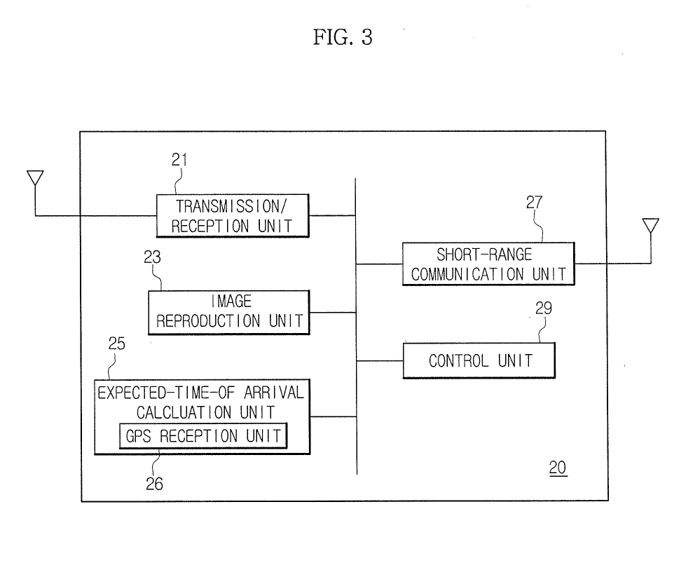

FIG. 3 is a schematic diagram showing the configuration of a first terminal according to an exemplary embodiment. The first terminal 20 includes a transmission/reception unit 21, an image reproduction unit 23, an expected time of arrival calculation unit 25, a short-range communication unit 27, and a control unit 29.

In this configuration, the transmission/reception unit 21 transmits the request for reproducing the image selected by the terminal user to the content providing server 10 and receives the image data and the buffering time transmitted from the content providing server 10 in response thereto.

The image reproduction unit 23 reproduces the image data received from the content providing server 10 through the transmission/reception unit 21 and provides the image data to the user.

The expected time of arrival calculation unit 25 detects the current position information of the terminal user while it moves to the destination, obtains an average speed, and calculates the expected time of arrival using a distance from the second terminal 300 and the average speed. The expected time of arrival may be calculated by Equation 2.

Expected time of arrival=distance from the second terminal/average speed Equation 2

In Equation 2, the distance from the second terminal may be a linear distance between the current position of the first terminal 20 and the current position of the second terminal 30, and the average speed may be (V₀+V₁+ . . . +Vₙ)/K, where K=n+1, and V₀, V₁, . . . , Vₙ are instantaneous speed values acquired at regular time interval.

In order to calculate the expected time of arrival, the distance from the second terminal 30 should be calculated. In order to calculate the distance from the second terminal 30, the position information of the second terminal 30 should be detected. In this regard, the first terminal 20 may store the position information of the second terminal 30 in a memory region and calculate the distance from the second terminal 30 using the position information of the second terminal 30 when calculating the expected time of arrival. Alternatively, whenever making the request for reproducing the image to the content providing server 10, the position information of the second terminal 30 may be received from the content providing server 10 and the distance from the second terminal 30 may be calculated using the position information of the second terminal 30 when calculating the expected time of arrival.

In order to calculate the expected time of arrival, the average speed should be calculated. In order to calculate the average speed, the current position of the first terminal 20 should be detected. In this regard, the current position information of the first terminal 20 may be detected using a GPS signal, position information of a 3G base station, and access information of a Wi-Fi access point (AP). The expected time of arrival time calculation unit 25 may obtain the average speed of the terminal user using the current position information of the first terminal 20. The expected time of arrival time calculation unit 25 may obtain the average speed of the first terminal 20 periodically.

The expected time of arrival calculation unit 25 may include a GPS reception unit 26 to receive the current positional coordinates of the first terminal 20 from a GPS satellite (not shown) and to detect the current position of the first terminal 20.

The short-range communication unit 27 may be activated under the control of the control unit 29 to retrieve the information about the second terminal 30 and to transmit a time stamp of a frame which is currently being reproduced in the first terminal 20 to the second terminal 30 using a short-range wireless communication method.

The short-range communication unit 27 may be implemented as a wireless local area network (WLAN), Bluetooth, radio-frequency identification (RFID), ZigBee, Wi-Fi, ultra-wideband (UWB), or the like.

The control unit 29 compares the expected time of arrival calculated by the expected time of arrival calculation unit 25 with the buffering time received from the content providing server 10 through the transmission/reception unit 21 and requests for transmission of content to the second terminal 30 to the content providing server 10 through the transmission/reception unit if the expected time of arrival is within the buffering time.

When arriving at a destination at which the second terminal 30 is installed, the short-range communication unit 27 is activated so as to connect to the second terminal 30. If the second terminal 30 is retrieved through the short-range communication unit 27, the time stamp of the frame which is currently being reproduced is transmitted to the second terminal 30 through the short-range communication unit 27.

If the second terminal 30 does not receive image data from the content providing server 10 and the reception of image data is delayed, for example, due to a network problem, the control unit 29 may transmit the image data buffered in the first terminal 20 to the second terminal 30 through the short-range communication unit 27. The control unit 29 may transmit the image data buffered in the first terminal 20 to the second terminal 30 in response to a request of the terminal user. Since the fixed second terminal 30 (for example, an IPTV) has better performance than that the mobile first terminal 20 (for example, a smart phone), the second terminal 30 which receives the image data buffered in the first terminal 20 may play back the image data.

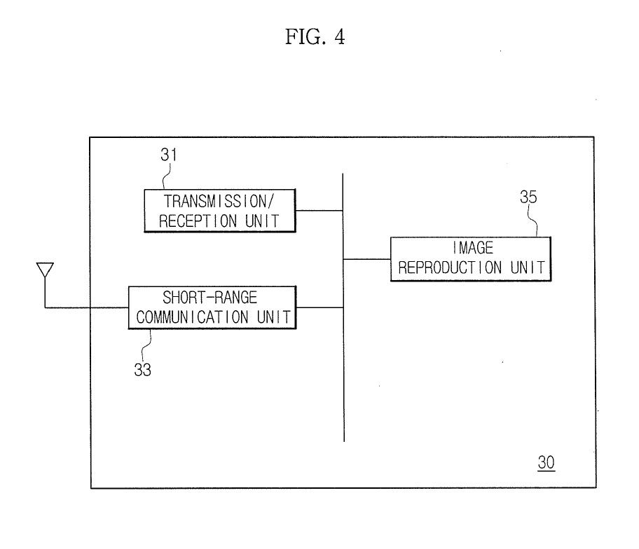

FIG. 4 is a schematic diagram showing the configuration of a second terminal according to an exemplary embodiment. The second terminal 30 includes a transmission/reception unit 34, a short-range communication unit 33, and an image reproduction unit 35.

The transmission/reception unit 31 may establish a session with the content providing server 10 in response to a connection request from the content providing server 10 and may receive image data of the expected time of arrival, i.e., image data to be displayed at about the expected time of arrival of the first terminal 20 to the location of the second terminal 30, transmitted by the connected content providing server 10.

The short-range communication unit 33 receives the time stamp transmitted from the first terminal 20, which is within a distance using the short-range wireless communication method.

The short-range communication unit 33 receives image data transmitted from the first terminal 20 using the short-range wireless communication method.

The image reproduction unit 35 retrieves a frame to be reproduced from the image data received through the transmission/reception unit 31 using the time stamp received from the first terminal 20 through the short-range communication unit 33 and performs reproduction from the retrieved frame.

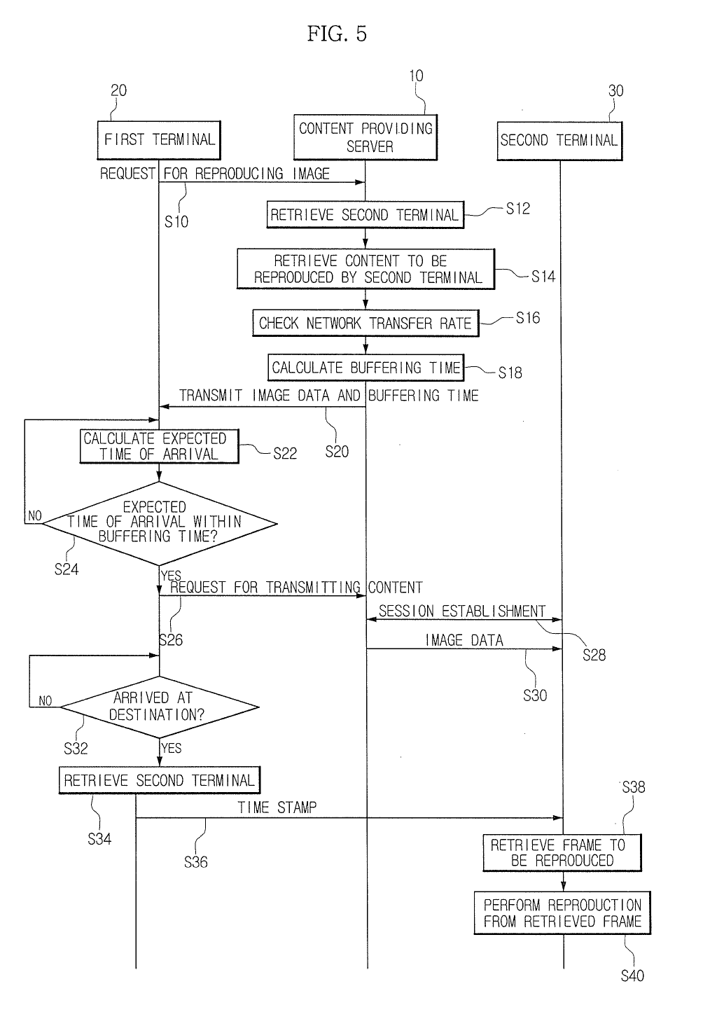

FIG. 5 is a flowchart illustrating a multi-screen service method according to an exemplary embodiment. First, if a terminal user who whishes to receive a multi-screen service accesses the content providing server 10 using the first terminal 20 and makes a request for reproducing an image selected by the terminal user in operation S10, the content providing server 10 retrieves information about the second terminal 30, i.e., the second terminal 30 used by the terminal user of the first terminal 20, from the terminal information DB 13 in operation S12 and retrieves content to be reproduced by the second terminal 30 from content of the image selected by the terminal user in the content DB 15 based on the information about the second terminal 30 in operation S14.

Thereafter, the content providing server 10 checks the current transfer rate of the network over which the second terminal 30 receives image data in operation S16. In operation S18, the content providing server 10 calculates the buffering time of the content to be transmitted to the second terminal 30 according to Equation 1, based on information (for example, the total number of frames of the content image, the total data size of the content image, and the like) about the content retrieved in operation S14 and the network transfer rate checked in operation S16.

In operation S20, the buffering time calculated in operation S18 and the image data of the image which is requested to be reproduced in operation S10 are transmitted to the first terminal 20.

In operation S20, the content providing server 10 may also transmit position information of a location at which the second terminal is installed.

The first terminal 20 which receives the image data and the buffering time from the content providing server 10 in operation S20, detects the current position information while reproducing the image data received from the content providing server 10 and providing the image data to the terminal user. In operation S22, the first terminal 20 calculates the expected time of arrival according to Equation 2.

In operation S24, the expected time of arrival calculated in operation S22 is compared with the buffering time received from the content providing server 10 in operation S20 to determine whether the expected time of arrival is within the buffering time.

In operation S26, if it is determined that the expected time of arrival is within the buffering time in operation S24, the request for transmitting content is made to the content providing server 10.

In operation S28, the content providing server 10, which receives the request for transmitting the content to the second terminal 30 from the first terminal 20 in operation S26, attempts to establish a connection with the second terminal 30. If the session connection with the second terminal 30 is completed in operation S28, the image data of the expected time of arrival is transmitted to the second terminal 30 in operation S30.

Upon arriving at a destination based on the detected current position information as determined in operation S32, the first terminal 20 activates the short-range communication unit 27 and retrieves information about the second terminal 30 in operation S34. The first terminal 20 transmits a time stamp of a frame, which is currently being reproduced at the first terminal, to the second terminal 30 using the short-range wireless communication method in operation S36).

In operation S38, the second terminal 30, which receives the time stamp from the first terminal 20 using the short-range wireless communication method in operation S36, retrieves a frame to be reproduced from the image data received in operation S30 from the content providing server 10 based on the time stamp received in operation S36 from the first terminal 20, and performs reproduction from the retrieved frame in operation S40.

According to the disclosed multi-screen service system and method for providing an image, it is possible to provide an image to a user by calculating a buffering time estimated in consideration of an image data size, a network environment, and an expected time of arrival, which is estimated in consideration of current position information and an average speed of a first terminal or a user, and making a request for transmitting content to a content providing server if the expected time of arrival is within the buffering time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A multi-screen service system, comprising:
a content providing server to receive a request for reproducing an image from a first terminal, to retrieve content to be reproduced by a second terminal from content of the image, to calculate a buffering time of the content based on an image data size and a network transfer rate, to transmit the buffering time and image data to the first terminal, and to transmit the image data of an expected time of arrival to the second terminal in response to a content transmission request of the first terminal; and
the first terminal to transmit the request for reproducing the image to the content providing server, to receive the buffering time from the content providing server, to determine the expected time of arrival, and to transmit the request for transmitting the content to the second terminal to the content providing server if the expected time of arrival is within the buffering time.

2. The multi-screen service system of claim 1, wherein the second terminal retrieves a frame to be reproduced from the image data received from the content providing server based on a time stamp received from the first terminal and performs reproduction of the image data from the retrieved frame.

3. The multi-screen service system of claim 1, wherein the network transfer rate is a network transfer rate of data to the second terminal.

4. The multi-screen service system of claim 1, wherein first terminal determines the expected time of arrival according to an average speed of the first terminal and a distance between the first terminal and the second terminal.

5. The multi-screen service system of claim 1, wherein the expected time of arrival is an expected time of arrival of the first terminal to a location of the second terminal.

6. The multi-screen service system of claim 1, wherein the image data of the expected time of arrival comprises image data reproduced by the first terminal at the expected time of arrival of the first terminal to a location of the second terminal.

7. A content providing server, comprising:
a terminal information database (DB) to store information about a plurality of terminals available to a multi-screen service;
a transmission unit to receive a request for reproducing an image from a first terminal of the plurality of terminals and to transmit a buffering time and image data to the first terminal;
a content DB to store content to be provided to the plurality of terminals;
a buffering time calculation unit to calculate the buffering time of the content to be transmitted to a second terminal of the plurality of terminals; and
a control unit to retrieve content to be reproduced by the second terminal from content of the image based on information about the second terminal in response to the image reproduction request of the first terminal and to transmit information about the retrieved content and a network transfer rate to the buffering time calculation unit.

8. The content providing server of claim 7, wherein the buffering time is defined as an image data size divided by network transfer rate,
where the image data size is equal to [(a number of frames to be transmitted)/(a total number of frames of the retrieved content)]×(a total data size of the retrieved content), and the network transfer rate is a number of packets to be transmitted per unit time.

9. The content providing server of claim 7, wherein the control unit connects to the second terminal in response to a request for transmitting content to the second terminal, the request for transmitting being received from the first terminal through the transmission/reception unit, and transmits the image data of an expected time of arrival to the connected second terminal.

10. A terminal, comprising:
a transmission/reception unit to transmit a request for reproducing an image to a content providing server and to receive image data and a buffering time from the content providing server;
an expected time of arrival calculation unit to detect current position information and to calculate an expected time of arrival; and
a control unit to transmit a request for transmitting content to a second terminal to the content providing server if the expected time of arrival calculated by the expected time of arrival calculation unit is within the buffering time.

11. The terminal of claim 10, wherein the first terminal further comprises a short-range communication unit to transmit a time stamp of a frame, which is currently being reproduced, to the second terminal.

12. The terminal of claim 10, wherein the expected time of arrival is defined as a distance of the first terminal from the second terminal divided by average speed of the first terminal,
where the distance from the second terminal is a linear distance between a current position of the first terminal and a current position of the second terminal, and the average speed is (V₀+V₁+ . . . +Vₙ)/K, wherein K=n+1, and V₀, V₁, . . . , Vₙ are instantancous speed values acquired at regular time intervals.

13. The terminal of claim 10, wherein the expected time of arrival calculation unit further comprises a Global Positioning System (GPS) reception unit to detect a current position of the first terminal.

14. A terminal, comprising:
a transmission/reception unit to receive image data of an expected time of arrival from a content providing server;
a short-range communication unit to receive a time stamp transmitted from a first terminal using a short-range wireless communication method; and
an image reproduction unit to retrieve a frame to be reproduced from the image data received from the content providing server using the time stamp and to perform reproduction from the retrieved frame.

15. A multi-screen service method, comprising:
transmitting a request for reproducing an image from a first terminal to a content providing server;
at the content providing server, retrieving content to be reproduced by a second terminal from content of the image and transmitting a buffering time of the content calculated in consideration of an image data size and a network transfer rate to the second terminal;
at the first terminal, determining an expected time of arrival and transmitting a request for transmitting the content to the second terminal to the content providing server; and
at the content providing server, transmitting image data of the expected time of arrival to the second terminal in response to the request for transmitting the content.

16. The multi-screen service method of claim 15, further comprising:
if the first terminal arrives at a location of the second terminal, transmitting a time stamp of a frame, which is currently being reproduced, to the second terminal; and
at the second terminal, retrieving a frame to be reproduced from the image data received from the content providing server based on the time stamp and performing reproduction from the retrieved frame.

17. The multi-screen service method of claim 15, wherein the calculating of the expected time of arrival comprises:
if the content providing server receives the request for reproducing the image from the first terminal, retrieving information about the second terminal from a terminal information database (DB);
retrieving content to be reproduced by the second terminal from the content of the image based on the information about the second terminal;
calculating the buffering time based on the image data size and the network transfer rate to the second terminal of the retrieved content; and
transmitting the calculated buffering time and the image data to the first terminal.

18. The multi-screen service method of claim 15, wherein the transmitting of the request for transmitting the content comprises:
at the first terminal, detecting current position information of the first terminal while reproducing the image data, and calculating the expected time of arrival; and
comparing the expected time of arrival and the buffering time and transmitting the request for transmitting the content to the second terminal to the content providing server if the expected time of arrival is within the buffering time
